(19) United States
(12) Patent Application Publication
(10) Pub. No.: US 2019/0168434 A1
(43) Pub. Date: Jun. 6, 2019

(54) OPTICAL INSPECTION SYSTEM FOR PREFORMS

(71) Applicant: Finatec Holding AG, Brügg b. Biel (CH)

(72) Inventors: Bernhard KUBALEK, Unterramsern (CH); Fridolin MAIBACH, Safnern (CH); Matthias HERMLE, Brügg b. Biel (CH)

(21) Appl. No.: 16/323,880

(22) PCT Filed: Aug. 14, 2017
(86) PCT No.: PCT/EP2017/070611

§ 371 Date: Feb. 7, 2019

(30) Foreign Application Priority Data
Aug. 23, 2016 (CH) 01080/16

(51) Int. Cl. B29C 45/76; G01N 21/90

(52) U.S. Cl. CPC B29C 45/7686; B29C 2945/7629; B29C 2945/76464; G01N 21/9081

(57) ABSTRACT

It is proposed to carry out an optical inspection of preforms (7) by means of at least one camera device (2, 3, 13), in such a way that the preforms (7) are in a relative position to each other that is unchanged in comparison with the injection molding operation.

The invention relates to a method for optical inspection of hollow bodies, in particular preforms, by means of at least one camera device. Furthermore the invention relates to an optical inspection system for hollow bodies, in particular preforms, with at least one camera device for making images of the surface regions of the preforms to be inspected.

Liquids, in particular also beverages, are being traded and sold to end consumers in plastic bottles in increasing quantities (magnitude). For hygienic reasons, logistical reasons (no return transport of empties) and cost reasons (production costs, quantities to be transported, etc.) one-way bottles are increasingly resorted to. Thus corresponding plastic containers are needed and are being used in large quantities.

To further reduce the transport costs, it has in the meantime become common practice for a “two-step” production process to be used for one-way plastic bottles, in which the two production steps are achieved, as a rule, at different locations. Thus preforms are usually produced at a first facility, which is independent of the actual beverage-filling (or other liquid-filling) plant (as a rule with respect to premises and economically) and which first facility moreover supplies other companies. For transport reasons (lesser volume) the preforms it produces are brought still as preforms to the beverage-filling plant. It is only there that the preforms are expanded to their full volume in the so-called stretch-blow method and then filled with the beverages (liquids).

Despite the great number of pieces, it is necessary for the plastic bottles—and thus also the preforms—to have at best a minimal defect rate. This is due to the fact that escaping liquids are at least problematic; in cases of chemical substances this can also be dangerous. Especially during filling of comestibles (mineral water, juices, soft drinks, spritzer, etc.) there is, as a rule, a still higher requirement for as minimal as possible a rate of defective plastic bottles, for reasons of food safety. Here it can even happen that an entire load must be called back when a defect appears—with corresponding economic consequences.

High quality requirements of this kind can only be achieved economically in that with the finished preforms a regular inspection is carried out, in particular an individual item check, so that preferably neither systematic nor random (statistical) defects can occur. For this purpose, diverse inspection methods have been proposed, which are mostly based on an optical inspection since an inspection operation of this kind can be achieved comparatively easily and unproblematically.

Thus described in the German patent document DE 10 2009 011 269 B3 is a method for identification of defects of preforms at injection molding machines in which the injection molds have a plurality of cavities for formation of preforms. The preforms are ejected out of the injection molding machine and are led randomly to the inspection system. In order to correlate possible defective parts with the cavity producing the corresponding preform, the cavities are provided with an individual identifier which is assigned to the respective preform and which can be captured by the inspection system. In this way, despite the random feeding of the preforms to the inspection device, it can be detected which cavity has problems, and if necessary follow-up control can be carried out or maintenance in another way. Thereby problematic is the increased inspection effort, an unavoidably not identical formation of preforms (which is undesired under certain circumstances) and, in addition, the problem that owing to the random sorting it cannot be excluded that parts which happen to be produced later are inspected earlier. Here, in the case of an automatic adaptation of the production operation, suitable suppression mechanisms must be achieved in order to prevent wrong adaptations or respectively “overshoots”.

Described in the international patent application WO 2016/020683 A1 is a further optical inspection system, in which a transfer device removes the finished preforms from an injection mold and places them on a larger number of parallel-disposed transport belts. The transport belts, designed and driven independently of one another, lead the preforms past a camera system (one camera system per conveyor belt), where the preforms are optically inspected while passing through. Then the preforms are collected in a receptacle, whereby defective preforms are released into a separate receptacle for defective preforms. A problem with the system described there is that in this system the cavity in the injection mold (designed typically as two-dimensional matrix array of cavities; thereby there are typically 10×20 places) is potentially not identifiable. Although there is, as a rule, a 1:1 correlation between one line of the injection mold matrix and the conveyor belt corresponding thereto; the problematic position in the line, as the case may be (i.e. the number of the columns of the injection mold cavities disposed like a matrix), cannot be indicated or can be indicated only with difficulty. Above and beyond this, should a preform fall down during transport (which can never be completely ruled out), then it can quickly lead to random correlations. This can, in turn, result in a possibly carried out automated readjustment step leading, on the contrary, to an increase in the defect rate. That performance of this kind cannot be tolerated for production-safety as well as economic reasons is clear.

Accordingly, the object of the present invention is to improve a method for optical inspection of preforms by means of a camera device over methods known in the state of the art for optical inspection of hollow bodies, in particular preforms. A further object of the invention consists in improving an optical inspection system for hollow bodies, in particular preforms, which has at least one camera device for making images of surface regions of the preforms to be inspected, to the extent that this system is improved compared with optical inspection systems known in the state of the art.

The present invention achieves these objects.

To this end it is proposed to carry out the method for optical inspection of hollow bodies, in particular preforms, by means of at least one camera in such a way that the hollow bodies, in particular preforms, are inspected in a relative position to each other that is unchanged in comparison with the injection molding operation. In other words, the relative position of the preforms to one another, which these preforms take relative to one another within the framework of the injection molding operation, is not dispersed/changed, at least not in a substantial way (certain tolerances are of course not completely excluded thereby). The relative position to one another can thereby relate to a translation and/or rotation of the respective preforms relative to one another. Thus, in other words, in particular the relative spacing of the preforms to one another can be substantially maintained. Above all this relates to spacing relative to one another in which the corresponding connection lines run in one plane, which is orthogonal to the longitudinal axes of the preforms. As a rule, it is desirable (and expedient; usually also achievable in a comparatively easy way), if additionally or alternatively also the relative position of the preforms to one another in relation to one direction, which lies parallel to the longitudinal axes of the preforms, remains substantially unchanged (effectively the height of the preforms relative to one another). In such a case advantages result, as a rule, with respect to the camera arrangements to be used for the optical inspection, so that these can usually be configured comparatively easily. It is also preferable if, additionally or alternatively, the relative angular position (rotational direction of the preforms) of the preforms to one another (in particular in addition to maintaining the relative spacing apart from one another) is realized in one, two and in particular also three directions. Often a comparatively simple mechanical construction can thereby be used. Above and beyond this, by maintaining the relative position of the preforms to one another additional information can be obtained in relation to any defects arising with the preforms. This can prove to be especially advantageous in particular also for automated correction of the injection molding facility, if applicable, for preventing further errors or respectively defective preforms. In particular with the proposed method it is astoundingly easily possible, upon recognition of a defect, to pinpoint precisely the individual cavity in which the error has occurred. With corresponding execution of the method it is furthermore usually also possible that the production cycle is known, so that prevented in particular can be that a preform produced later is inspected earlier for arbitrary reasons, which can bring with it corresponding problems especially in the case of automated error correction. Even though in the present case one speaks of hollow bodies or respectively preforms, the invention is not necessarily limited to hollow bodies or respectively preforms in the actual sense. Of course it is also conceivable that the present proposed method (and thus also the device suitable therefor) can be used for parts/containers/cavities/bottles/vessels/container arrangements of substantially any desired kind, as in particular also for (repeated) inspection of typically stretch-blown plastic bottles, for example shortly before their filling with liquids. Furthermore it is to be pointed out that the term “preform” is often described using other terminology, such as, for example, “premolding”, “premold”, “PETling” and the like (without this supposing to be an exhaustive list). Since the present invention is especially advantageously usable in connection with preforms, in the case under consideration, for reasons of simplicity, usually only “preforms” are spoken of, although also hollow bodies and other parts/containers/cavities/bottles/vessels/vessel arrangements are also meant. The requirement that the relative position of the preforms to one another remains unchanged refers usually to (substantially) all preforms which are produced in an injection mold during an injection molding work cycle. It is also possible, however, that only a (preferably predetermined) portion of the preforms and/or only the majority of the preforms that are produced in an injection mold during an injection molding work cycle are supposed to remain unchanged with respect to their relative position to one another. In particular, it is conceivable, for example, that the preforms that are produced in an injection mold during an injection molding work cycle are removed from the injection mold as two parts, whereby within one part the preforms remain (substantially) unchanged with respect to their relative position to one another; the two parts are handled separately from one another, however (for example, removal of the produced preforms of the one part in a first direction and removal of the produced preforms of the second part in a second direction different from the first). Of course a different number of partial quantities can also be used here. The partial quantities can thereby be the same size; it is also conceivable however that the number in the respective partial quantities differs.

It is proposed that with the proposed method the mouth regions and/or threaded regions of the hollow bodies, in particular preforms, are examined, in particular examined preferentially and/or more precisely and/or with higher resolution and/or more intensely and/or for other features and/or for a greater number of features. It is of course thereby possible that additionally or alternatively also other regions of the preforms are examined. Where appropriate it is also conceivable, however, that only the mouth regions or respectively threaded regions of the preforms are examined. The proposed further embodiment of the method is due to the fact that flaws occur (significantly) more frequently especially in the threaded region or respectively in the mouth region of the preforms owing to the more complex construction there or respectively flaws occurring there are especially problematic with respect to the finished plastic bottle/the plastic bottle filled with liquid. Understood by “threaded region” or respectively “mouth region” can be in particular the region of the preform in which the actual threading (which in the end co-operates with the closing cap) is formed (in particular it can thereby be the actual, usually protruding, threading), and/or the mouth region (i.e. the region which in the closed state of the plastic bottle co-operates in a sealing way with the closing cap, so that typically the escape of liquids and/or gases—especially carbon dioxide in the case of carbonated beverages; and/or the influx of gases—in particular oxygen from the air which could lead to an oxidation of chemicals and beverages—can be prevented) and/or a protruding ridge region adjacent to the actual threading (on which the finished bottle can be gripped and/or transported and which often co-operates with a safety ring of the closing cap, to be put on later, to achieve security against manipulation of the closed plastic bottle). As a rule, it is especially advantageous when not just one or two, but instead typically all three of the mentioned features are examined in particular. This of course does not exclude other surfaces in this region also being examined (in particular on the outside and/or the inside of the preform). To be mentioned as features which are inspected (if need be, separately) are in particular absence of bubbles, sufficient thickness, correct shape, smooth surface, correct color and the like.

It is proposed furthermore that the method is carried out in such a way that during at least part of the optical inspection process the hollow bodies, in particular preforms, are still located inside at least part of the injection mold, in particular by their end opposite the mouth region and/or threaded region. In other words, one could also say that the preforms are located with their bodies (partially) in the removal gripper, in particular in such a way that the mouth region or respectively threaded region protrudes out of the removal gripper. In this context it is also to be pointed out that the injection mold, as a general rule, is produced as multi-part injection mold. Usually a subdivision takes place (among other things) to the effect that the elongated, substantially unstructured hollow cylinder region is produced in an own part of the injection mold, while the head region, which also comprises in particular (parts of) the threaded region, is produced in one or more separate part(s) of the injection mold especially therefor. If at least one part of the optical inspection operation is carried out in such a way that (parts of) the hollow cylindrical region are still located (are “stuck”) in the respective part of the injection mold, the unchanged relative arrangement, being proposed here, of the preforms relative to one another (compared with the injection molding operation) can be maintained in an especially easy way. On the contrary, the unchanged relative positioning of the preforms results “automatically” to a certain extent, i.e. without separate steps and/or special design of the injection mold and/or without separate actions. Even if it is absolutely possible that (parts of) of the threaded region of the preforms are still located inside the injection mold, the proposed way of proceeding, in which the preforms, with their end opposite the threaded region (i.e. the hollow cylindrical end), are still located inside a portion of the injection mold, is especially advantageous because in this case the often particularly susceptible threaded region, to be inspected particularly precisely, can be well inspected in a simple way. Pointed out only for the sake of completeness is that it is of course possible that in addition to the proposed optical inspection step, still further (if necessary, optical) inspection steps are carried out.

Additionally or alternatively, it is also possible that the method can be carried out in such a way that during at least part of the optical inspection procedure the hollow bodies, in particular preforms, are located outside the injection mold, in particular are located at least in part within a removal device for removal of hollow bodies, in particular preforms, out of the injection mold and/or are located at least in part in a transfer device for transfer of hollow bodies, in particular preforms, from one position to another position. Such removal devices/removal tools are often present anyway with preform injection molding procedures in order to achieve, for example, the removal of the preforms out of (parts of) the injection mold. Removal devices of this kind are usually analogous to the injection mold of matrix-like design (matrix-like arrangement of cavities), designed often likewise as a kind of matrix of individual gripping tools, whereby the individual gripping tools are arranged corresponding to the preforms still located inside (parts of) the injection mold. In this way also with removal devices known per se in the state of the art (it being possible for certain modifications to be necessary, where appropriate, such as in particular the additional arrangement of camera devices) the unchanged relative position of the preforms to one another can be maintained also during the removal procedure or respectively thereafter. In particular it is possible for a removal device to be combined with a transfer device, i.e. for example in such a way that the removal device removes the preforms from the respective part of the injection mold and then transfers them to a transfer device, which as a general rule is likewise of matrix-like design, which then passes the preforms on to further devices and/or, where appropriate, releases them into a receptacle (or a plurality of receptacles).

Furthermore it is proposed that during at least part of the optical inspection operation the hollow bodies, in particular preforms, are gripped in the area of the mouth region and/or threaded region, in particular on their inner side. This relates particularly (but not necessarily) to the case where the optical inspection operation (a part of the optical inspection operation) is carried out when the preforms are located in a removal device for removal of the preforms from the injection mold. With a gripping on the inner side it is possible in an especially easy way to keep the threaded region “optically accessible” for an optical inspection. Moreover it is possible for the gripping devices to be provided with a kind of illumination device so that an illumination of the preforms from their inside is facilitated. This can make possible an especially simple optical inspection and/or an optical inspection with especially high degree of fidelity. The term of a “gripping device” is to be interpreted potentially broadly. Examples can be not just mechanically operating gripping elements but also in particular vacuum grippers or the like.

It can furthermore prove to be advantageous when the method is carried out in such a way that the at least one camera device is moved, in particular between a resting position of the at least one camera device and an optical inspection position of the at least one camera device, and/or during the optical inspection operation (this is possible during the entire inspection operation or parts thereof). The further embodiment, in which the at least one camera device is moved, in particular between a resting position of the camera device and an optical inspection position of the camera device is then especially advantageous when during the respective part of the optical inspection operation the preforms are substantially in a resting position. This can be the case, for example, when part of the injection mold has already been removed from the preforms (for example the part with which the threaded region of the preforms is molded), while the other regions of the preforms are still located in the part of the injection mold corresponding to them. Although it is true that the operation of the camera device takes a certain amount of time, it can however be kept relatively short, in particular in relation to the injection molding operation, which lies typically in the range of 10 seconds and longer. The time needed for the operation of the optical inspection device can moreover be used in an advantageous way since in this time the preforms can cool off to a certain extent before they are mechanically stressed by removal from the injection mold. The camera device can moreover be rigidly connected to a removal device, which is present where necessary. It is thereby possible for the camera device to become operational while the removal device is active and/or to be disposed at the height of the removal device (so that the optical inspection can take place when the removal device is located immediately in front of the injection mold filled with preforms and shortly before the removal device with the grippers reaches into the formed preforms). It is also possible, however, for the camera device to form together with the removal device a common slide in such a way that the common slide is moved into a first position in which the optical inspection takes place and then still further into a second position (pushed a bit further), in which the removal device can become active. Additionally or alternatively, it is possible for the camera device to be moved during the optical inspection operation. In this case it is possible for any travel time to be used for the actual optical inspection. Even when the mentioned further embodiment of a movable camera device often proves to be advantageous, it can in contrast also proved to be advantageous when the camera device (or parts thereof) is (are) mounted in a fixed way. In particular mechanical stresses on the camera devices can thereby be avoided and if necessary a higher optical quality can also be attained. In particular it is also conceivable that with rigid and/or movable camera device a relative movement of camera device and preforms is achieved. Such a relative movement can make it possible for the field of vision of the camera device to be selected as comparatively small and nevertheless for a large area to be able to be covered (precisely because of the movement). Thus the camera range of a two-dimensionally photographing or imaging camera device can be selected to be small, which, where applicable, can go along with an especially high resolution accurate with respect to details. It is also conceivable, however, for the camera device to be designed, for example, as a line of photo transistors or respectively light-sensitive elements or as so-called line scan camera with other structure and for a “complete” two-dimensional picture to nevertheless be attained, owing to the relative travel movement. Likewise it is conceivable that a light section picture by means of a laser is used for scanning, in particular for scanning of mouth regions and/or threaded regions of preforms.

Furthermore it is proposed that the method is designed in such a way that the optical inspection takes place from different directions and/or in oblique inspection, in particular in relation to the longitudinal axis of the hollow bodies, in particular preforms, and/or in relation to the longitudinal axis of the threaded region of the hollow bodies, in particular preforms. In such a case it is possible, on the one hand, with a single camera device (referring to one line of vision) or a reduced number of camera devices to inspect optically a complete matrix configuration of preforms. Since preferably the entire area of a preform (in particular the entire area in the mouth region, respectively threaded region, of a preform) should be optically inspected, it is typically expedient to provide for different shooting directions. In particular a view from two, three, four, five, six, seven, eight, nine or ten different directions is appropriate. The directions can thereby relate in particular to an angular position in top view, parallel to a longitudinal axis of a preform/of a threaded region of a preform. In combination with an inclined view, a number of visual axes can thereby be achieved, which are directed toward the tip of a circular cone (whereby the tip of the circular cone does not necessarily have to lie in the plane of the opened injection mold).

It can prove to be advantageous when the method is carried out in such a way that the optical inspection takes place using at least one, preferably a plurality of, camera devices and/or using at least one, preferably a plurality of, reflection devices, in particular takes place using at least one, preferably a plurality of, mirror devices. With the proposed further embodiment it is possible in particular, to achieve the required number of visual axes in an especially effective way. If reflection devices/mirror devices are used, the number of camera devices can be kept at a comparatively low level, if necessary, despite a comparatively high number of different lines of sight. This is in particular the case when the respective range of vision of a respective camera device captures not only an area of the surface of a preform to be inspected (or a plurality thereof), but additionally also one or more reflection devices/mirror devices, with which further surface areas of one or more preforms can be captured, deviating from the first line of vision. Of course lenses, prisms or other optical devices can also be used in addition to, or as an alternative to, reflection devices and/or mirror devices.

Furthermore it is proposed to design the method in such a way that the optical inspection method is carried out using at least one illumination device. With such an illumination device the quality of the optical inspection can be typically increased. Thereby conceivable are normal illumination devices such as lamps, spotlights and the like. It is also possible, however, to provide for a kind of stroboscope or respectively flash unit. It is also possible to adapt the light source specially to the feature to be inspected, so that, for example, any gas bubble inclusions in particular clearly emerge optically and can thereby be captured in an especially easy way. It is thereby possible in particular to use light from different spectral ranges (such as, for example, ultraviolet spectral range, infrared spectral range, visible spectral range) and/or individual selected colors (in particular also selected from the mentioned spectral ranges) individually and/or in combination with each other.

Furthermore it is proposed to carry out the method in such a way that at least one camera device is designed as digital camera device and/or numerical analysis methods are used for analysis of the optical information obtained by means of the at least one camera device. An automated capturing and evaluation of any defects which occur can thereby be achieved in an especially easy way. Digital camera devices and/or numerical methods of analysis of pictures thereby obtained are widely used and commercially available.

In particular it is proposed to further embody the method in such a way that output data are generated which can be used in particular for follow-up control of an injection molding operation. This too is often already possible with numerical analysis methods known per se in the state of the art. Thanks to the proposed optical inspection method, however, the input data can be of an especially high quality and can be attributed to an individual cavity of the injection mold in correct positional arrangement, so that the obtained output data can have an especially high value.

For the sake of completeness it is pointed out that—although the present invention relates to an optical inspection method—it is of course readily possible for still further checking methods to be used in addition to the proposed method. In particular additional checking methods can be used which are also based in particular on different physical principles. Especially a thickness check by means of application of pressure (in particular pneumatic testing) or other mechanical checking come to mind.

Proposed furthermore is an optical inspection system for hollow bodies, in particular preforms, which has at least one camera device for making images of surface areas of the preforms to be inspected and which is designed and set up such that it carries out an optical inspection method of the type proposed in the foregoing. The optical inspection system can have the same advantages and features at least in an analogous way. Moreover it is possible to further embody the optical inspection system in the sense of the previous description, at least in analogous form. By means of such a further embodiment, the advantages and features, likewise already described, of the respective further embodiment can also be achieved for the optical inspection system in at least an analogous way.

In particular it is proposed to design the optical inspection system in such a way that at least one, preferably a plurality, of digital camera devices are provided, at least one of the camera devices being disposed preferably in a movable and/or rigid way. It is thereby possible that all camera devices are disposed in a movable way and/or all camera devices are disposed in a rigid way. It is also conceivable, however, that part of the camera devices is disposed in a movable way, while another part of the camera devices is rigidly disposed (in the case of presence of a plurality of camera devices). The advantages and features already described in connection with the proposed method can thereby be realized also for the optical inspection system in an analogous way.

Proposed moreover is to provide the optical inspection system with at least one removal device, which has at least one gripping device for removal of preforms, from at least one part of an injection mold and/or for transfer of preforms, between two positions. The gripping device can thereby seize preferably an inner side, but if necessary also an outer side, of the preforms (the latter in particular in a hollow cylindrical region of the preforms remote from the threaded region). A seizing of the inner side of the preforms is advantageous in particular in the area of the threaded region. As already mentioned, vacuum grippers in particular can also be used. The advantages and features already mentioned in connection with the present proposed method can also result here as well, at least in an analogous way.

Proposed furthermore is to design the optical inspection system in such a way that provided is at least one programmable control unit for control of the components of the optical inspection system and/or for analysis of the information obtained from the at least one camera device and/or for calculation of output data, which can be used in particular for follow-up control of an injection molding operation. Electronic control units of this kind can be available, for example, in the form of a programmable computer, a work station, a programmable single-board computer or the like. Such components are obtainable today in a cost-effective way also with high capacity. Especially suitable computer programs, in particular also commercially available and/or already existing computer programs can run on the respective programmable control units.

Further details of the invention and in particular embodiments, given by way of example, of the proposed device and of the proposed method will be explained in the following with reference to the attached drawings.

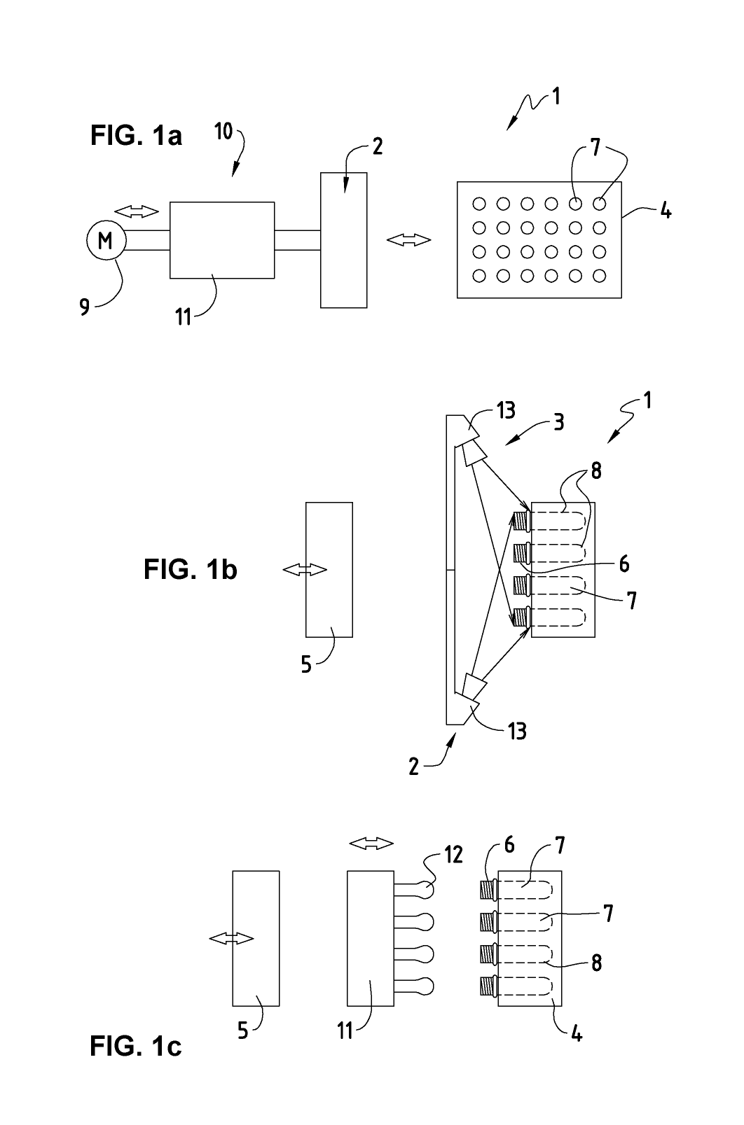

FIG. 1 shows an injection molding machine with a first embodiment example of an optical inspection system for carrying out an optical inspection method in different views and positions;

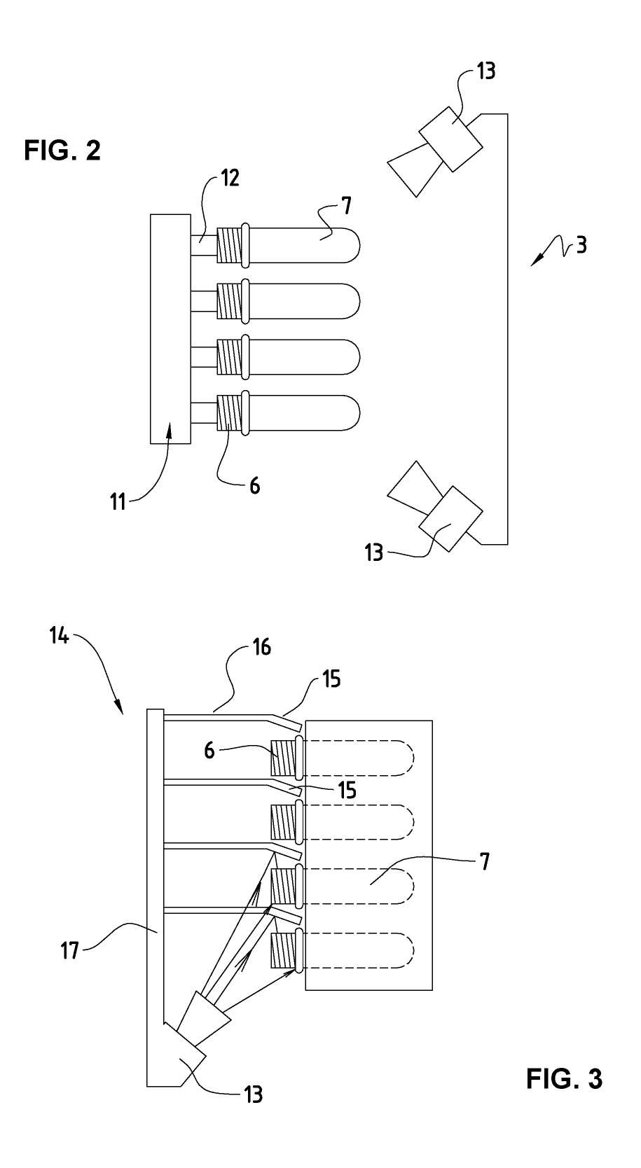

FIG. 2 shows a second embodiment example of an optical inspection system for carrying out an optical inspection method in schematic lateral plan view;

FIG. 3 shows a third embodiment example of an optical inspection system for carrying out an optical inspection method in schematic lateral plan view;

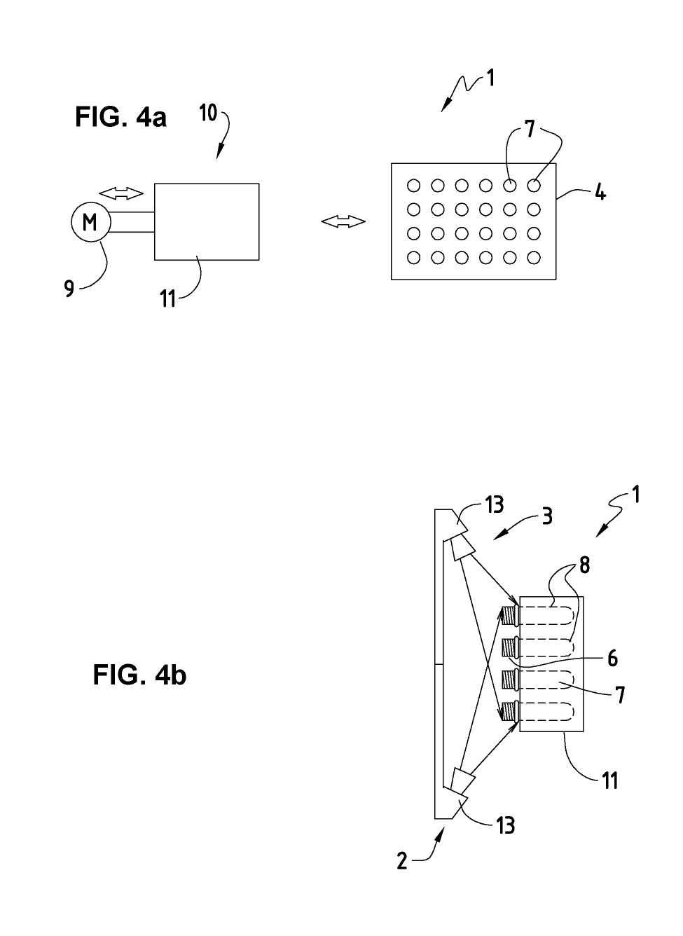

FIG. 4 shows an injection molding machine with a fourth embodiment example of an optical inspection system for carrying out an optical inspection method in different views and positions.

Shown respectively in FIG. 1 in schematic top view is an injection molding machine 1 with optical inspection system 2 in the form of a camera array 3 from different viewing directions. The injection molding machine 1 has here a split injection mold 4, 5, which consists of a plurality of injection mold parts 4, 5, which can be moved in a way relative to one another and above and beyond this can, if need be, be moved within themselves. Especially for the molding of a thread 6 for the preforms 7 (only partially visible, respectively, in FIG. 1), usually required is a multi-part injection mold part 5, movable within itself. Such injection mold parts 4, 5 are known per se in the state of the art and are therefore not described in detail, for reasons of conciseness. The relative maneuverability of the two injection mold parts 4, 5 of the injection mold 1 is moreover indicated by a double arrow in FIG. 1. Mentioned for the sake of completeness is that in the top view of FIG. 1a one injection mold part 5 of the injection mold 4, 5 is not shown, for reasons relating to technical drawing. The affected injection mold part 5, on the other hand, is to be seen in the lateral plan views according to FIG. 1b and FIG. 1c (in addition to the injection mold part 4).

The injection mold 4, 5 is designed in such a way that a plurality of preforms 7 can be produced in a single injection molding operation. In the present example, the cavities 8 for formation of the preforms 7 are designed as a type of matrix of, here, four lines and six columns. Of course dimensions differing therefrom are also conceivable. Also the configuration of the individual cavities 8 is not limited to a rectangular grid.

To form the preforms 7, the injection mold parts 4, 5 of the injection mold are placed flush on one another and plastic material (in the food sector often PET=polyethylene) is injected in heated, as a rule semifluid, form into the cavities 8 of the injection mold 4, 5 under high pressure. Serving to form a hollow space in the preforms 7 are corresponding male forms, which are provided in the “top” 5 of the injection mold 4, 5. In FIG. 1 these are situated in a retracted position and are therefore not visible.

After the preforms 7 have been formed and have cooled off sufficiently, the injection mold 4, 5 is opened by opening the two injection mold parts 4 and 5.

As soon as the injection mold parts 4, 5 have moved sufficiently apart, a slide 10, drivable by means of an actuator 9, is driven into the formed interim space between the two injection mold parts 4, 5. The slide 10 was located during the actual injection molding operation here on the side with respect to the closed injection mold 4, 5 (comparable in particular also with FIG. 1a). The actuator 9 is indicated only schematically here. Appropriate here is, for example, a linear motor or a servomotor/stepping motor, which can drive the slide 10 linearly, for example by means of a toothed rack.

The slide 10 consists here of two main components connected firmly to one another, namely the actual optical inspection system 2 and a removal gripper 11, which, with the aid of various gripping elements 12 (see FIG. 1c), is able to take the finished preforms 7 out of the respective mold part 4. Owing to the selected perspective of FIG. 1a only the back sides of the optical inspection system 2 and of the removal gripper 11 are to be seen, so that no details can be discerned.

Shown schematically in FIG. 1b in lateral plan view is the carrying out of the inspection operation. As can be seen from FIG. 1a, the optical inspection system 2 here is designed comparatively narrowly and in particular does not have the same dimensioning as that of the injection mold components 4, 5. This is for cost reasons since in this way the number of digital cameras 13 of the digital camera arrays 3 can be reduced. Also the necessary travelling distances of the “entire slide 10” can usually be thereby reduced, which can bring both space savings as well as savings in time in operation. In particular the digital cameras 13 of the camera array 3 are disposed in such a way that at a given point in time only a portion of the injection mold part 4 and thereby only part of the finished preforms 7 can be optically inspected. For example, at a given point in time only one or two columns of the preform configuration can be inspected.

Drawn here in FIG. 1b is a digital camera array 3 of two digital cameras 13. Based on the indicated fields of vision of the individual cameras 13, it can be seen that the threaded region 6 of the preforms 7 can be optically inspected. Owing to the different viewing directions of the two digital cameras 13, different sides can be inspected, so that altogether the entire threaded region 6 of each preform 7 is visible. To increase the inspection quality it is of course also conceivable that three or four digital cameras 13 are disposed, of which each has to optically inspect a sector of at least 120° (three digital cameras 13) or respectively 90° (four digital cameras 13) (of course a greater number of digital cameras 13 is possible, whereby the sector becomes correspondingly smaller). In reality it of course makes sense to provide for a certain overlap between the individual picture areas in order, on the one hand, to increase the quality of the optical inspection, on the other hand to compensate for certain position tolerances, in particular also based on vibrations. The overlapping picture area, for example, can amount to up to 5°, 10°, 15°, 20°, 25° or 30° (or another magnitude).

For the sake of completeness it should still be mentioned that of course an increased number of digital cameras 13 of the camera array 3 can thereby arise in that the fields of vision of the individual digital cameras 13 are selected in such a way that they do not examine any complete column of preforms 7, but rather only part of a column (if necessary also only an individual preform 7). The required depth of field of the picture can thereby be reduced so that simpler optics can be used for the digital cameras 13 and/or the resolution of the obtained picture (of the obtained pictures) can be increased so that the quality of the optical inspection can increase further.

Thus while the slide 10 is driven linearly, the optical inspection system 2 sweeps gradually over the injection mold part 4 with the preforms 7 located therein, so that altogether a complete image results. The obtained picture data are transmitted to a computer (or another programmable device), where they are analyzed for any flaws using generally known algorithms.

The advantage with this proposed method here consists in that the preforms 7 are located exactly in the relative position with respect to one another in which they were injection molded. Thus, upon discovery of a defect, the cavity 8 in the injection mold 4, 5, in which the defect has occurred can be clearly determined. It is possible that by changing the process parameters the occurrence of the defect in future preforms 7 can thereby be prevented, if necessary, in an automated way. Even if a manual intervention should be required, it would not be necessary first to carry out a search for the defective cavity 8, so the maintenance time can be reduced and thus the downtime of the injection molding machine 1 can be clearly reduced where applicable. A correspondingly increased productivity is the result.

The slide 10, which is driven out of the resting position shown in FIG. 1a in the direction of the opened injection mold 4, 5, moves afterwards continuously further until the removal grippers 11 with the individual gripping elements 12 (see FIG. 1c) are located in a removal position, which is situated opposite the corresponding injection mold part 4. This position is shown in FIG. 1c.

As soon as the position is reached, the removal gripper 11 is driven in the direction of the opened injection mold part 4 (lowered), so that the gripping elements 12 can seize the individual preforms 7 on their inner side. Then the removal gripped 11 is withdrawn (lifted) and the preforms 7 are pulled out of the cavities 8 of the respective injection mold part 4. This plunging and pulling out movement is indicated in FIG. 1c by a double arrow.

After removal of the preforms 7 out of the injection mold part 4, the individual preforms 7 stick on the corresponding gripping elements 12 of the removal gripper 11, so that a configuration in the sense of FIG. 2 results. Then the slide 10 with the removal gripper 11 is driven back in the direction of the resting position, so that the space between the two injection mold parts 4, 5 becomes free again and a new injection molding production cycle can begin.

The preforms 7 located on the gripping elements 12 of the removal gripper 11 can then be transferred to a further transfer element in an ordered way, or can also be ejected randomly into a collecting box, however (usually a plurality of collecting boxes, such as (at least) one box for defect-free preforms 7, as well as (at least) one collecting box for defective preforms 7). Both are basically known and are not shown here.

As can be gathered from FIG. 1, the additional time and effort involved with the optical inspection method proposed here is astonishingly minimal. In particular no additional acceleration or braking procedures are required. The sole difference to a “normal” removal gripper 11 without optical inspection device consists in that here a slide 10 with a certain extension in the form of an optical inspection system 2 must be provided. This has as a result that, on the one hand, the travelling distance of the slide 10 has to be selected to be a little longer (to “compensate” the dimension of the optical inspection system 2 and its attachment); above and beyond this are somewhat greater masses to be moved (i.e. in particular to accelerate and brake). In relation to the removal gripper 11, however, the optical inspection system 2 has usually a comparatively minimal mass, so that this effect is usually negligible. But also the time loss from the additional travelling distance is usually minimal with today's travel speeds. To name typical values: while the actual injection molding operation with closed injection mold 4, 5 lies in a time range of at most 10 to 30 seconds, the time loss from the additional travelling distance is in the range of ¼ second—and thus almost completely negligible.

Shown schematically in a lateral plan view in FIG. 2 is a further embodiment of an optical inspection system for carrying out an optical inspection method. Here the removal gripper 11, on whose gripping elements 12 the preforms 7 are located, is moved linearly past a camera array 3 of a plurality of digital cameras 13, whereby the camera array 3 is rigidly mounted.

The optical inspection step according to FIG. 2 can, on the one hand, be carried out in addition to the optical inspection according to the embodiment example according to FIG. 1, so that now also the hollow cylindrical region of the preforms 7 (remote from the threaded region 6 of the preforms 7) can be optically inspected. This is in particular of advantage since the preforms 7 are still within the respective injection mold parts 4 during the optical inspection method according to FIG. 1 and are thus not <completely> visible. The optical inspection can thereby be “complemented” to a certain extent.

It is however also conceivable that an optical inspection is carried out exclusively with a configuration according to FIG. 2. The digital cameras 13 of the camera array 3 are then positioned in such a way that in particular they are also able to catch the threaded region 6 of the preforms 7. As a rule, appropriate therefor is that the axes of vision of the individual digital cameras 13 are selected in such a way that they do not lie parallel to the lines or respectively columns of the cavities 8 of the injection mold part 4, 5 or respectively the configuration in lines or respectively columns of the gripping elements 12 of the removal gripper 11. With preforms 7 spaced sufficiently apart from one another it is then absolutely possible to inspect the preforms 7 optically, in particular also their threaded regions 6, even if this seems impossible with the selected simplified drawn representation in FIG. 2.

As a general rule, however, it is advantageous if an inspection method in the sense of FIG. 1 is combined with an inspection method in the sense of FIG. 2 (i.e. an optical inspection from different directions with respect to the longitudinal axis of the preforms 7 takes place so that these are able to be inspected optically in an especially precise way over their entire length). Of course optical inspection methods differing from FIG. 1 and/or from FIG. 2 can also be used.

Shown in FIG. 3 is a further optical inspection system 14. In order to reduce the number of digital cameras 13, in the optical inspection system 14 shown in FIG. 3 a plurality of mirrors 15 are attached to a basic element 17 by means of suitably disposed and dimensioned supporting rods 16, whereby the basic element 17 also supports the digital cameras 13. The optical inspection system 14 can be used, for example, instead of the optical inspection system 2 according to FIG. 1.

As can be seen, the individual mirrors 15 are arranged in such a way that the entire field of vision of the digital camera 13 can encompass both the front sides and the back sides (referring to the placement of the digital camera 13) of the threaded region 6 of the preforms 7. A reduced number of digital cameras 13 can thereby be sufficient.

Of course in an analogous way to what was said in relation to FIG. 1, it is also possible that a digital camera 13 is not responsible for a complete column of preforms 7, but instead respectively for just a lesser number of preforms 7 (if necessary also for just one single preform). The required depth of field can thereby be reduced, which has already been discussed. This of course does not apply just for the embodiment example shown in FIG. 3, but also for the embodiment example shown in FIG. 2 as well as for other embodiments not shown here of an optical inspection system.

Only for reasons of completeness it is pointed out that a plurality of mirrors 15 can be provided per preform 7, so that, for example, by means of a “direct camera view” and two mirrors, a sector of 120° can be inspected in each case (typically plus safety margin, as already mentioned).

Shown in FIG. 4 is a variation of the method shown in particular in FIG. 1 or respectively of the device shown there.

Here the injection mold opens with the injection mold parts 4, 5 after the actual injection molding operation in such a way that the bodies of the preforms 7 (the region of the preforms 7 opposite the respective threaded area 6) after the opening of the injection mold protrude outwardly, while the preforms 7 are still located with their threaded regions 6 in the respective injection mold part 4 or 5 (and are held there).

The removal gripper 11 is then moved by the actuator 9 (see FIG. 4a) over the respective injection mold part (here 4) and takes the preform out of the injection mold part 4. The removal gripper 11 can thereby be designed in an advantageous way as vacuum-applied removal gripper 11 (which has a plurality of cavities 8 for receiving body regions of the preforms 7, to each of which a partial vacuum or a vacuum can be applied, and thus are able to hold the respective preform 7 “in position”).

The optical inspection then takes place according to FIG. 4b by means of the optical inspection system 2, which has one or more digital cameras 13, whereby the optical inspection system 2 is positioned opposite the removal gripper 11 (through movement of the optical inspection system 2 and/or through movement of the removal gripper 11). The threaded regions 6 (and moreover also the mouth regions) of the preforms 7 can then be optically inspected in an especially advantageous way.

Furthermore, the preceding description, in particular the description given with respect to FIG. 1, applies in an analogous way also to the present embodiment example according to FIG. 4.

1. Method for optical inspection of hollow bodies, in particular preforms, by means of at least one camera device, wherein the hollow bodies, in particular preforms, are examined in an unchanged relative position to each other with respect to an injection molding operation.

2. Method according to claim 1, wherein the mouth regions and/or threaded regions of the hollow bodies, in particular preforms, are examined, in particular examined preferentially and/or more precisely and/or with higher resolution and/or more intensely and/or for other features and/or for a greater number of features.

3. Method according to claim 1, wherein during at least part of the optical inspection process the hollow bodies, in particular preforms, are still located inside at least part of the injection mold, in particular by their end opposite the mouth region and/or threaded region.

4. Method according to claim 1, wherein during at least part of the optical inspection procedure the hollow bodies, in particular preforms, are located outside the injection mold, in particular are located at least in part within a removal device for removal of hollow bodies, in particular preforms, out of the injection mold and/or are located at least in part in a transfer device for transfer of hollow bodies, in particular preforms, from one position to another position.

5. Method according to claim 4, wherein during at least part of the optical inspection operation the hollow bodies, in particular preforms, are gripped in the area of the mouth region and/or threaded region, in particular on their inner side.

6. Method according to claim 1, wherein the at least one camera device is moved, in particular between a resting position of the at least one camera device and an optical inspection position of the at least one camera device, and/or during the optical inspection operation.

7. Method according to claim 1, wherein the optical inspection takes place from different directions and/or in oblique inspection, in particular in relation to the longitudinal axis of the hollow bodies, in particular preforms, and/or in relation to the longitudinal axis of the threaded region of the hollow bodies, in particular preforms.

8. Method according to claim 1, wherein the optical inspection takes place using at least one camera device and/or using at least one reflection device, in particular takes place using at least one mirror device.

9. Method according to claim 1, wherein the optical inspection method is carried out using at least one illumination device.

10. Method according to claim 1, wherein at least one camera device is designed as digital camera device and/or numerical analysis methods are used for analysis of the optical information obtained by means of the at least one camera device.

11. Method according to claim 10, wherein output data are generated which can be used in particular for follow-up control of the injection molding operation.

12. Optical inspection system for hollow bodies, in particular preforms, having at least one camera device for photographing surface areas of the hollow bodies to be inspected, in particular preforms, wherein it is designed and set up in such a way that it carries out an optical inspection method according to claim 1.

13. Optical inspection system according to claim 12, characterized by at least one digital camera device, whereby the at least one digital camera device is movably and/or rigidly disposed.

14. Optical inspection system according to claim 12, characterized by at least one gripping device for removal of hollow bodies, in particular preforms, from at least one part of an injection mold and/or for transfer of hollow bodies, in particular preforms, between two positions.

15. Optical inspection system according to claim 12, characterized by at least one programmable control unit for control of the components of the optical inspection system and/or for analysis of the information obtained from the at least one camera device and/or for calculation of output data, which can be used in particular for follow-up control of the injection molding operation.
